(19) United States
(12) Patent Application Publication
(10) Pub. No.: US 2026/0230357 A1
(43) Pub. Date: Aug. 6, 2026

(54) METHODS FOR GENERATION AND EQUALIZATION OF WAVEFORM THAT TIME MULTIPLEXES REFERENCE SIGNAL AND DATA

(71) Applicant: WISIG NETWORKS PRIVATE LIMITED, Hyderabad, Telangana (IN)

(72) Inventor: Koteswara Rao Gudimitla, Srikalahasti, Andhra Pradesh (IN)

(21) Appl. No.: 19/152,160

(22) PCT Filed: Feb. 22, 2024
(86) PCT No.: PCT/IN2024/050191

§ 371 Date: Jul. 30, 2025

(30) Foreign Application Priority Data
Mar. 7, 2023 (IN) 202341015100

(51) Int. Cl. H04L 27/26

(52) U.S. Cl. CPC H04L 27/2607

(57) ABSTRACT

Embodiments of the present disclosure relate to generating a waveform without a cyclic prefix. The method comprising generating, by a transmitter, at least one data sequence, at least one reference sequence (RS) and a portion of at least one RS. The at least one RS comprises at least one of a RS block, a RS cyclic prefix (CP) and a RS cyclic suffix (CS). Also, the method comprises time multiplexing the at least one data sequence with the at least one RS to generate at least one multiplexed sequence and filtering the at least one multiplexed sequence to obtain at least one filtered symbol. Further, the method comprises generating a waveform using the at least one filtered symbol. The portion of the at least one RS is repeated within the symbol.

### CROSS-REFERENCE TO RELATED APPLICATIONS

This application claims priority from the Indian Provisional Patent Application No. 202341015100 filed on Mar. 7, 2023, the entirety of which are hereby incorporated by reference.

### TECHNICAL FIELD

Embodiments of the present disclosure are related, in general to communication, but exclusively relate to methods and apparatus for generating and transmitting a waveform that time multiplexes data and using reference signals (RS) and exploits the multiple reference signals available within a OTFDM symbol for efficient design of transmitter and receiver including channel estimation, equalization and tracking and compensation of time varying channel phase with OTFDM symbol.

### BACKGROUND

Third Generation Partnership Project (3GPP) has developed 5G-NR standards to support use cases like eMBB, URLLC, MMTC. It has been agreed to use CP-OFDM waveform and DFT-s-OFDM waveform for uplink transmission in 5G-NR. Here, CP-OFDM is mainly used for higher data rates, while, because of its low PAPR and high-power efficiency, DFT-s-OFDM is used to serve the cell edge UEs. In DFT-s-OFDM, the data is first precoded by taking a DFT of allocation size before mapping the data to the allocated sub-carriers. The DFT-s-OFDM is essentially a single carrier modulation scheme. Hence, DFT-s-OFDM has lower PAPR compared to OFDM. Furthermore, DFT-s-OFDM has similar robustness to the frequency selective fading as OFDM as cyclic prefix is introduced to reduce Inter Symbol Interference (ISI).

To further reduce the PAPR of DFT-s-OFDM waveform, waveform-based solutions like Pi/2-BPSK modulation is used to modulate the user data. On the DFT precoded pi/2-BPSK symbols spectrum shaping filter is applied to reduce the PAPR further. Low PAPR allows the signal to be transmitted at higher transmitting power by reducing the PA power back-off. However, spectrum shaping along with DFT precoding may not show much effect on the PAPR of higher modulation schemes resulting in no improvement in increasing the transmit signal power. Additionally, current 5G standards uses slot structure, where user data is transmitted in series of OFDM symbols. A typical slot structure comprises of one or more data symbols and one or more reference symbols.

6G Mobile Communication System requires a method of information transmission and that offers extremely low latency, very high data rate, and very high-power efficiency. DFT-S-OFDM waveform, which is power efficient and supports high data rates is well suitable for this purpose. However, to achieve extremely low latency, it is desirable to transmit the information (like user data, RS, and control information) in a single shot i.e., using a single OFDM symbol. However, conventional DFT-S-OFDM requires at least one data symbol and at least one reference symbol (RS). The RS is required for the purpose of estimating the channel state information (CSI) and subsequent equalization of data symbol. The current two-symbol structure in 5G-NR not only doubles the latency (compared to single symbol case), but also has a higher RS overhead i.e., 50%. Additionally, both the waveforms CP-OFDM and DFT-s-OFDM use the cyclic prefix as a guard band for each symbol, also to obtain the cyclic convolution property on the received symbol. In 5G-NR, CP occupies at least one symbol duration in one shot transmission, resulting in significant overhead on the usage of resources, affecting spectral efficiency and latency in processing. Hence, there is a need for a new type of waveform that allows one shot transmission with low PAPR with flexible RS overhead and high-power efficiency along with addressing efficient generation of transmit waveform, and effective utilization of RSs for both channel estimation, equalization, tracking and compensation of time varying channel phase within OTFDM symbol.

FIG. 1 shows an illustration of a wireless communication network. As shown in the FIG. 1, the base station (BS) is in communication with the users, also referred as user equipment's (UEs) or user device or mobile or mobile device. The BS is also referred to as cell or gnB. The FIG. 0 further shows an uplink and downlink i.e. two-way communication links between the BS and UEs. These measure the bandwidth and signal strength of data transmission between a user device and a base station or access point. The uplink is the transmission of data from a user device to a base station. Downlink is the transmission of data from a base station to a user device. For example, when a mobile device initiates a call, it establishes a wireless connection on an uplink frequency to a cell tower or base station. The base station then amplifies the signal and sends it on a downlink frequency to the intended recipient.

A cell ID number is a unique identifier assigned to each cell tower by a cellular network. This identifier is used to distinguish one cell tower from another and is crucial for routing calls and text messages to the correct tower. In wireless communication networks, cells are divided into different sectors, and each sector is assigned a unique Physical Cell ID.

### SUMMARY

The shortcomings of the prior art are overcome and additional advantages are provided through the provision of method of the present disclosure.

Additional features and advantages are realized through the techniques of the present disclosure. Other embodiments and aspects of the disclosure are described in detail herein and are considered a part of the claimed disclosure.

In one aspect of the present disclosure a method for transmitting a waveform is disclosed. The method comprising generating, by a transmitter, at least one data sequence, at least one reference sequence (RS) and a portion of at least one RS. The at least one RS comprises at least one of a RS block, a RS cyclic prefix (CP) and a RS cyclic suffix (CS). Also, the method comprises time multiplexing the at least one data sequence with the at least one RS to generate at least one multiplexed sequence and filtering the at least one multiplexed sequence to obtain at least one filtered symbol. Further, the method comprises generating a waveform using the at least one filtered symbol. The portion of the at least one RS is repeated within the symbol.

In another aspect of the present disclosure a method of processing a received waveform is provided. The method comprising performing filtering on the received waveform to obtain a plurality of samples for collecting at least one of: at least one received RS and at least one data from the obtained samples of the received waveform. Also, the method comprises performing channel estimation using the collected at least one received RS to obtain at least one estimated RS channel. Further, the method comprises equalizing the at least one received data using the at least one estimated RS channel to obtain at least one equalized data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1 shows an illustration of a wireless communication network;

FIGS. 2A and 2B shows OTFDM symbol structure with data and RS, in accordance with an embodiment of the present disclosure;

FIG. 2C shows an illustration of an OTFDM symbol with data sequence and without RS, in accordance with an embodiment of the present disclosure;

FIG. 2D shows an illustration of an OTFDM symbol with RS and without data sequence, in accordance with an embodiment of the present disclosure;

FIG. 2E shows an illustration of a slot comprising a plurality of OTFDM symbols, in accordance with an embodiment of the present disclosure;

FIG. 2F shows an illustration of a slot comprising a plurality of OTFDM symbols, in accordance with another embodiment of the present disclosure;

FIG. 2G shows an illustration of OTFDM symbols structure, in accordance with an embodiment of the present disclosure;

FIG. 2H shows a block diagram of a communication system for generating an Orthogonal time frequency-division multiplexing (OTFDM) waveform, in accordance with an embodiment of the present disclosure;

FIG. 3 shows a block diagram illustration of a communication system for generating an OTFDM waveform, in accordance with an alternate embodiment of the present disclosure;

FIG. 4A shows an illustration of transmitting an OTFDM symbol using a communication system, in accordance with an embodiment of the present disclosure;

FIG. 4A shows an illustration of transmitting an OTFDM symbol using a communication system, in accordance with another embodiment of the present disclosure;

FIG. 5A shows an illustration of transmitting an OTFDM symbol using a communication system, in accordance with another embodiment of the present disclosure;

FIG. 5A shows an illustration of transmitting an OTFDM symbol using a communication system, in accordance with yet another embodiment of the present disclosure;

FIG. 6 shows a block diagram of a receiver, in accordance with an embodiment of the present disclosure;

FIG. 7A shows a block diagram of a receiver, in accordance with some embodiments of the present disclosure;

FIG. 7B shows an illustration of a channel estimation performed by the receiver of FIG. 7A, in accordance with some embodiments of the present disclosure;

FIG. 7C shows an illustration of an equalization performed by the receiver of FIG. 7A, in accordance with some embodiments of the present disclosure;

FIG. 8A shows a block diagram of a receiver, in accordance with another embodiment of the present disclosure;

FIG. 8B shows an illustration of a receiver pre-processing unit of the receiver of FIG. 8A, in accordance with an embodiment of the present disclosure;

FIG. 9A shows a block diagram of a receiver, in accordance with yet another embodiment of the present disclosure;

FIG. 9B shows an illustration of a receiver pre-processing unit of the receiver of FIG. 9A, in accordance with an embodiment of the present disclosure;

FIG. 10 shows an illustration of OTFDM symbol structures, in accordance with some example embodiments of the present disclosure;

FIG. 11 shows an illustration of transmitting a plurality of OTFDM symbols using a communication system, in accordance with an embodiment of the present disclosure;

FIG. 12 shows an illustration of transmitting a plurality of OTFDM symbols using a communication system, in accordance with another embodiment of the present disclosure;

FIG. 13 shows an illustration of transmitting a plurality of OTFDM symbols using a communication system, in accordance with another embodiment of the present disclosure; and

FIG. 14 shows an illustration of transmitting a plurality of OTFDM symbols using a communication system, in accordance with yet another embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Embodiments of the present disclosure relate to generating a generalized Orthogonal time frequency-division multiplexing (OTFDM) waveform. In conventional OFDM systems, the RS and user data are transmitted in different OFDM symbols, such that channel estimation to equalize the data can be estimated clearly at the receiver, and CP is added to each symbol that results in excess overhead. The present disclosure provides a method for generating a generalized OTFDM waveform with or without CP and exploits the RS for both channel estimation and tracking and compensation of time varying channel phase.

Embodiments of the present disclosure are related, in general to communication, but exclusively relate to methods and apparatus for generating and transmitting a waveform that time multiplexes data and using reference signals (RS) and exploits the multiple reference signals available within a OTFDM symbol for efficient design of transmitter and receiver including channel estimation, equalization and tracking and compensation of time varying channel phase with OTFDM symbol.

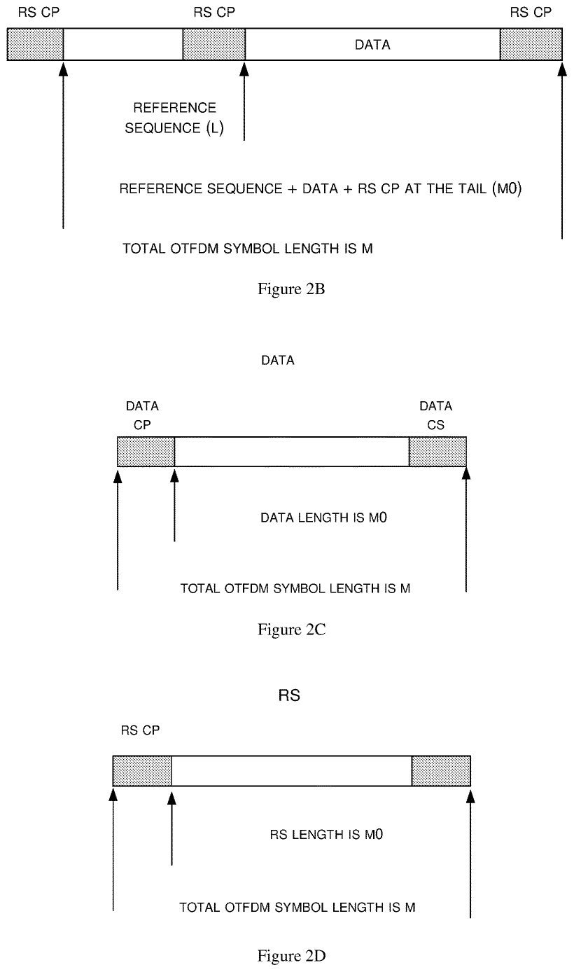

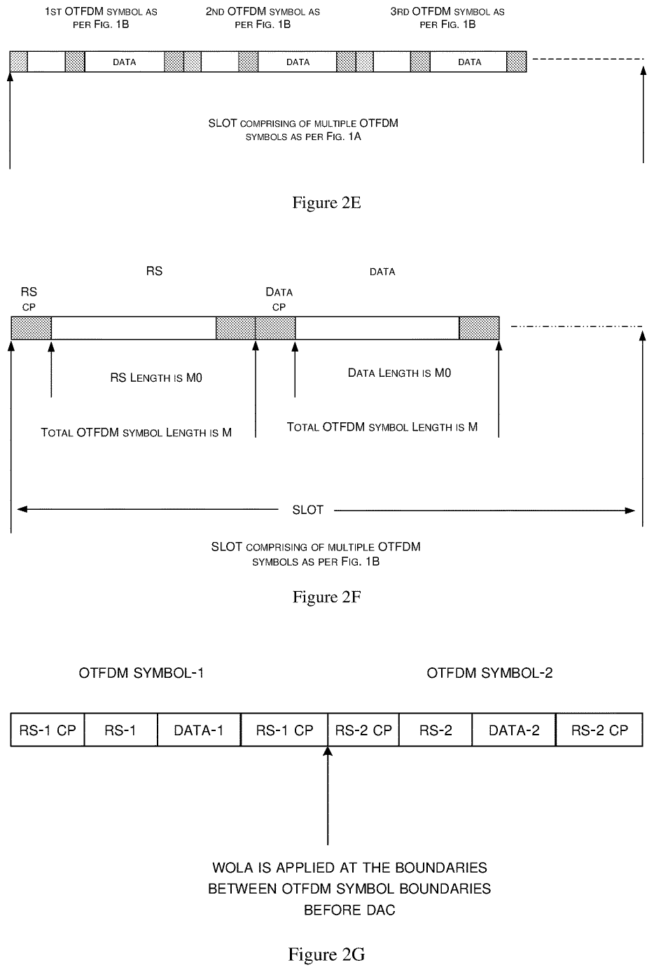

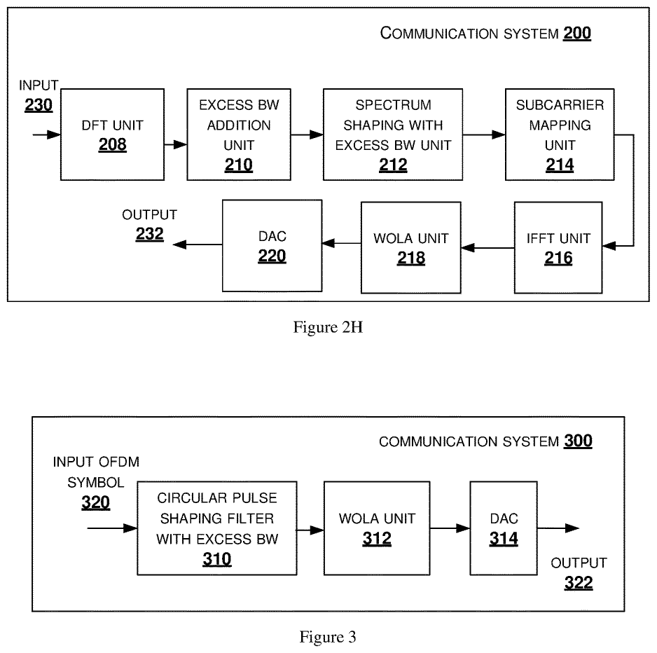

FIG. 2A shows a generalized Orthogonal time frequency-division multiplexing (OTFDM) symbol (referred to as OTFDM in the sequel) structure with data and RS. The length of the OTFDM symbol is M, comprising of reference sequence (RS), RS cyclic prefix (RS CP), RS cyclic suffix (RS CS) and data. The RS CP is the last portion of the RS. The RS CS is the starting portion of the RS. The tail end of data includes RS CP and RS CS. Therefore, RS CP and RS CS repeats in three places within OTFDM symbol. In an embodiment, the tail of data is appended with only a portion of RS CP and RS CS. In such case, this portion repeats in three different places within the OTFDM symbol. In another embodiment, the data comprises an optional phase tracking reference sequence (PT-RS) that is exploited for phase compensation, at the receiver. This PT-RS together with RS CP and RS CS which repeat in time enables estimation and compensation of time varying phase within the OTFDM symbol, particularly important at high carrier frequencies.

As shown in the FIG. 2A, the combination of RS CP and RS CS which is present at both the beginning and at the end of the OTFDM symbol allows the signal to exhibit circular symmetry for a portion of the OTFDM symbol even after passing through a time domain waveform generation which includes filtering or pulse shaping and a propagation channel. Furthermore, the combination of RS CP followed by RS CS acts as a guard between successive OTFDM symbols. In an embodiment the full or portion of RS CP and RS CS may be generated as a function of Base Station ID or Sector ID or Transmitter ID and the receiver may use these signals that repeat in time for synchronization purposes such as Primary Synchronization Signal (PSS) or Second Synchronization Signal (SSS), the data may convey Physical Broadcast Channel (PBCH), Physical Downlink Control Channel (PDCCH) or Physical Downlink Shared Channel (PDSCH) information. In another embodiment of the full or portion of RS CP and RS CS may be generated as a function of Base Station ID or Sector ID or UE ID such as RNTI and the receiver may use these signals that repeat in time for synchronization purposes such as the data may convey Physical Uplink Control Channel (PUCCH) or Physical Uplink Shared Channel (PUSCH) information.

FIG. 2B is an alternative implementation to FIG. 2A where an RS CP is appended to the RS and the same RS CP is added to the data at the end of data. As shown in FIG. 2B, the RS CP which is present at both the beginning and at the end of the OTFDM symbol allows the signal to exhibit circular symmetry for a portion of the OTFDM symbol even after passing through a time domain waveform generation module or a propagation channel. Furthermore, the RS CP acts as a guard between successive OTFDM symbols. The RS CP which repeats in time may be used for estimation of time varying phase within the OTFDM symbol. In an embodiment, the tail of data is appended with only a portion of RS CP. In such case, this portion repeats in three different places within the OTFDM symbol. In an embodiment the full or portion of RS CP may be generated as a function of Base Station ID or Sector ID or Transmitter ID and the receiver may use these signals that repeat in time for synchronization purposes such as Primary Synchronization Signal (PSS) or Second Synchronization Signal (SSS), the data may convey Physical Broadcast Channel (PBCH), Physical Downlink Control Channel (PDCCH) or Physical Downlink Shared Channel (PDSCH) information. In another embodiment of the full or portion of RS CP may be generated as a function of Base Station ID or Sector ID or UE ID such as RNTI and the receiver may use these signals that repeat in time for synchronization purposes such as the data may convey Physical Uplink Control Channel (PUCCH) or Physical Uplink Shared Channel (PUSCH) information.

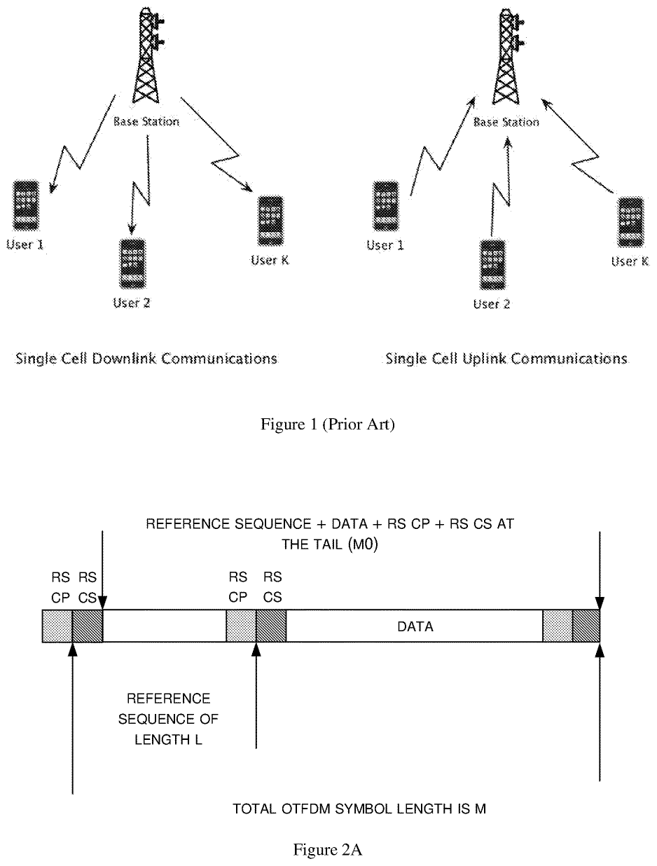

FIG. 2C shows an illustration of an OTFDM symbol, with data sequence, without RS. As shown in FIG. 2C, the OTFDM symbol does not include RS but includes Data CP at the beginning of OTFDM symbol, and Data CP followed by Data CS at the tail of the OTFDM symbol. In an embodiment of FIG. 1C, the combination of Data CP and Data CS which is present at both the beginning and at the end of the OTFDM symbol allows the signal to exhibit circular symmetry for a portion of the OTFDM symbol even after passing through a time domain waveform generation module or a propagation channel. Furthermore, the combination of Data CP followed by Data CS acts as a guard between successive OTFDM symbols. In another embodiment, the OTFDM symbol includes Data CP at the beginning of OTFDM symbol, Data and Data CP at the tail of the OTFDM symbol. In an embodiment, the tail of data is appended with only a portion of DS CP and Data CS. In such case, this portion repeats in two different places within the OTFDM symbol. The Data CP and the Data CS which repeat in time may be used for estimation of time varying phase within the OTFDM symbol.

FIG. 2D shows an illustration of an OTFDM symbol, with RS, without data sequence. As shown in FIG. 2D, the OTFDM symbol does not include Data but includes RS CP at the beginning of OTFDM symbols and RS CP at the tail of the OTFDM symbol. In an embodiment of FIG. 1D, the RS CP which is present at both the beginning and at the end of the OTFDM symbol allows the signal to exhibit circular symmetry for a portion of the OTFDM symbol even after passing through a time domain waveform generation module or a propagation channel. Furthermore, the RS CP acts as a guard between successive OTFDM symbols. In an embodiment, the tail of RS is appended with only a portion of RS CP. In such case, this portion repeats in two different places within the OTFDM symbol. The RS CP and the RS CS which repeat in time may be used for estimation of time varying phase within the OTFDM symbol.

FIG. 2E shows an illustration of a slot comprising a plurality of OTFDM symbols, in accordance with an embodiment of the present disclosure. Each of the OTFDM is as per the FIG. 2A. As shown in FIG. 2E, the slot format is shown that comprise of multiple OTFDM symbols that are transmitted in succession. The OTFDM symbols may comprise of RS only, data only and data and RS.

FIG. 2F shows an illustration of a slot comprising a plurality of OTFDM symbols, in accordance with another embodiment of the present disclosure. Each of the OTFDM is as per the FIG. 2B. As shown in FIG. 2F, the slot format is shown that comprise of multiple OTFDM symbols that are transmitted in succession.

FIG. 2G shows an illustration of OTFDM symbols structure, in accordance with an embodiment of the present disclosure. As shown in FIG. 2G, the OTFDM symbols structure includes two OTFDM symbols, each OTFDM symbol comprises an RS-CP, RS, data and RS-CS. That is the first OTFDM symbol (OTFDM symbol-1) incudes RS-1 CP, RS-1, data-1 and RS-1 CS. The second OTFDM symbol (OTFDM symbol-2) incudes RS-2 CP, RS-2, data-2 and RS-2 CS. WOLA is applied at the boundaries between the OTFDM symbols before the digital to analog conversion (DAC). Also, as shown in FIG. 2G, the illustration comprises a plurality of OTFDM symbols. Each of the plurality of OTFDM symbol is as shown in FIG. 2B.

One embodiment of the present disclosure is a method for generating a symbol. The method comprising generating, by a transmitter, at least one data sequence, at least one reference sequence (RS) and a portion of at least one RS. The at least one RS comprises at least one of a RS block, a RS cyclic prefix (CP) and a RS cyclic suffix (CS). Also, the method comprises time multiplexing of the at least one data sequence with the at least one RS to generate a multiplexed sequence. Further, the method comprises filtering the multiplexed sequence to obtain a symbol or filtered symbol. In an embodiment, the symbol is an orthogonal time frequency-division multiplexing (OTFDM) symbol. In an embodiment, the method comprises generating a waveform from the obtained symbol. This generation of the waveform comprises at least one of up-sampling, time domain filtering, weighted overlap and add (WOLA) and digital to analog conversion (DAC), frequency up-conversion. The generated waveform is an OTFDM waveform. The at least one data sequence is referred to as data or data sequence. The at least one RS is referred to as RS or RS sequence.

In an embodiment, a portion of the RS is appended at the tail end of the symbol. A portion of at least one RS is the RS CP. A portion of at least one RS is portion of RS CP. In an embodiment, a portion of at least one RS is the RS CP and the RS CS. The portion of at least one RS is a portion of the RS CP and the RS CS.

The at least one data sequence is one of a pi/2 binary phase shift keying (BPSK) sequence, a BPSK sequence, a Quadrature Phase Shift Keying (QPSK) sequence, M-ary Quadrature Amplitude Modulation (QAM) sequence, and an M-ary Phase Shift Keying (PSK) sequence. The at least one data sequence comprises at least one of a data block, data cyclic prefix and a data cyclic suffix. In an embodiment, the at least one data sequence comprises at least one data block and a phase tracking reference signal (PTRS). The data includes at least one of a user data and a control information. The data sequence and the RS sequence are pi/2-BPSK, wherein the multiplexed sequence is rotated by 90 degrees between successive elements of the multiplexed sequence to generate a rotated multiplexed sequence. The data sequence includes at least one data, and at least one of a data cyclic prefix (CP) and a data cyclic suffix (CS).

The RS is one of a pi/2 binary phase shift keying (BPSK) sequence, a BPSK sequence, a Zadoff-Chu (ZC) sequence, a Quadrature Phase Shift Keying (QPSK) sequence, a M-ary Phase Shift Keying (PSK) sequence and a computer-generated sequence.

The multiplexed sequence comprises two reference sequences (RSS), a first RS is located at RS starting position of multiplexed sequence and a second RS is located at RS ending position of multiplexed sequence. The tail of the data is appended with a portion of data CP and data CS, said portion repeats in two different places within the OTFDM symbol, wherein the data CP and the data CS which repeat in time is used for estimation of time varying phase within the OTFDM symbol. The RS sequence includes at least one RS block, at least one of a RS cyclic prefix (CP) and a RS cyclic suffix (CS).

In an embodiment, the at least one RS or a portion of the at least one RS is generated as a function of at least one of a Base Station ID, Sector ID, Transmitter ID and UE ID. The tail of data is appended with a portion of RS CP, said portion of RS CP repeats in three different places within the OTFDM symbol. The tail of data is appended with a portion of DS CP and Data CS, said portion repeats in two different places within the OTFDM symbol, wherein the data CP and the data CS which repeat in time is used for estimation of time varying phase within the OTFDM symbol.

In an embodiment, the RS tail is appended with a portion of RS CP, said portion repeats in two different places within the OTFDM symbol, wherein the RS CP and the RS CS which repeat in time is used for estimation of time varying phase within the OTFDM symbol. In an embodiment, a tail of the RS CP is appended with a portion of RS CP, said portion repeats in two different places within the OTFDM symbol, wherein the RS CP acts a CP for the OTFDM symbol.

In an embodiment, the RS CP is appended to the RS and the same RS CP is appended at the end of data in an OTFDM symbol, said RS CP provides circular symmetry for a portion of the OTFDM symbol. A combination of RS CP and RS CS which is present at both the beginning and at the end of the OTFDM symbol allows the signal to exhibit circular symmetry for a portion of the OTFDM symbol. The size of the RS CP or RS CS is a function of one of channel conditions, modulation order, coding rate, impulse response of spectrum shaping filter and power capability of the transmitter. In an embodiment, length of the at least one RS or portion of at least one RS is a function of at least one of an operating SNR, modulation and coding scheme assigned to a user, channel conditions between a transmitter and a receiver, and a Doppler shift between a transmitter and a receiver. The length of the at least one RS or portion of the at least one RS is a function of at least one of an operating SNR and a Doppler shift between a transmitter and a receiver.

The filtering of the multiplexed sequence is performed using circular convolution of multiplexed sequence and one or more filter coefficients, to obtain a symbol or filtered symbol. In an embodiment, the filtering comprises a linear convolution of multiplexed sequence and one or more filter coefficients. In another embodiment, the filtering comprises a polyphase filtering of multiplexed sequence with one or more polyphase filter coefficients. The filtering is performed on the multiplexed sequences comprises bandwidth expansion. The filtering is performed by the transmitter on the one or more multiplexed sequences comprises an expanded bandwidth discrete Fourier transform spread orthogonal frequency-division multiplexing (DFT-s-OFDM) symbol.

FIG. 2H shows a block diagram of a communication system for generating a Generalized Orthogonal time frequency-division multiplexing (OTFDM) waveform, in accordance with an embodiment of the present disclosure. The communication system 200 is also referred to as a transmitter or an OTFDM transmitter or an OTFDM symbol generator.

As shown in the FIG. 2H, the communication system 200 comprises a Discrete Fourier Transform (DFT) unit 208, an excess BW addition unit 210, a spectrum shaping with excess BW unit 212, a sub-carrier mapping unit 214, an inverse Fast Fourier transform (FFT) unit 216, a WOLA unit 218 and DAC 220. The communication system 200 also includes a processing unit to process the generated waveform. The input 230 is at least one OTFDM symbol as per the format described in FIG. 2A or FIG. 2B or FIG. 2C or FIG. 2D or a succession of OTFDM symbols that may include the OTFDM symbols as per any of the formats of FIGS. 2E-2F. in an embodiment, as shown in Figures a portion of the at least one RS is appended at the tail end of the symbol. Also, in an embodiment the portion of at least one RS is the RS CP. In an embodiment, a portion of at least one RS is portion of RS CP. In an embodiment, a portion of at least one RS is the RS CP and the RS CS. In another embodiment, a portion of at least one RS is a portion of the RS CP and the RS CS.

The DFT unit 208 transforms an input 230 using a Discrete Fourier Transform (DFT) to generate a transformed sequence. The DFT unit performs M-point DFT on the input 230 to generate transformed sequence.

The excess bandwidth (BW) addition unit 210 performs padding operation on the transformed multiplexed sequence i.e. prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. The value of the N1 is at least zero, and value of the N2 is at least zero. The values of N1 and N2 may be same or different. The value of N1 and N2 may depend on the excess power that is sent by the transmitter.

The spectrum shaping with excess BW unit 212, also referred as a shaping unit or a filter, performs shaping of the extended bandwidth transformed multiplexed sequence to obtain a shaped extended bandwidth transformed multiplexed sequence or shaped sequence. The filter used for the shaping operation on the extended bandwidth transformed multiplexed sequence is one of a Nyquist filter, square root raised cosine filter, a raised cosine filter, a hamming filter, a Hanning filter, a Kaiser filter, an oversampled GMSK filter and any filter that satisfies predefined spectrum characteristics.

The sub carrier mapping unit 214, also referred as a mapper or a sub carrier mapper or a mapping unit, performs subcarrier mapping on the shaped extended bandwidth transformed multiplexed sequence or shaped sequence with at least one of localized and distributed subcarriers to generate a mapped extended bandwidth transformed multiplexed sequence. In an embodiment, the distributed subcarrier mapping includes insertion of zeros in to the extended bandwidth transformed multiplexed sequence.

The IFFT unit 216 performs inverse IFFT on the shaped extended bandwidth transformed multiplexed sequence to produce a time domain sequence. The a weighted with overlap and add operation (WOLA) unit 218 performs windowing, weighted with overlap and add operation on the time domain sequence to minimize any blocking effects, and fades out any spectral coding error at the frame boundaries to suppress discontinuities to generate an WOLA output. The DAC 220 converts the WOLA output which is digital into an analog output 232, referred as an OTFDM waveform.

In an embodiment, the communication system 200 includes a processing unit to process the time domain sequence to generate an OTFDM symbol. The processing unit comprises a post IFFT cyclic prefix (CP) addition unit which is an optional block, an up-sampling unit, a bandwidth parts (BWP) specific rotation unit, a RF up-conversion unit. The output of processing unit is fed to the digital to the DAC 220.

The time domain sequence is generated by the IFFT unit 216, which is fed to the processing unit. The processing unit performs at least one of a symbol specific phase compensation, an addition of symbol post IFFT cyclic prefix using the CP addition unit, up sampling using the up-sampling unit, addition of symbol cyclic suffix, windowing, weighted with overlap and add operation, bandwidth parts (BWP) rotation using BWP specific rotation unit, an additional time domain filtering, sampling rate conversion to match DAC rate, frequency shifting on the time domain waveform using RF up conversion unit and converting the same into analog using the DAC to generate the output, which is at least one OTFDM waveform, in an embodiment. The output waveform offers low peak to average ratio (PAPR).

The data and the RS are multiplexed before DFT-precoding in the time domain. To support better channel estimation either cyclic pre-fix (RS-CP) or cyclic post-fix (RS-CS) or both pre-fix and post-fix is added to the RS in the time domain. The sequence to be used as RS is one of pi/2-binary phase shift keying (BPSK), a Quadrature Phase Shift Keying (QPSK), M-ary Phase Shift Keying (PSK), and Zadoff-chu (ZC) sequence. The sequences may be obtained using one of m-sequences, Pseudo-Noise (PN) sequences, Kasami, Walsh, and Hadamard codes. The RS and RS-CP or RS-CS may occupy a portion of resources allocated to the transmitter, which may depend on at least one of channel conditions, excess bandwidth, transmitter allocation size, modulation order, coding rate, and other parameters like impulse response of spectrum shaping filter.

In an embodiment, to maintain optimized PAPR the user data used is pi/2-BPSK modulated, then pi/2-BPSK based reference sequences are used, and phase continuity is maintained between the RS and user pi/2-BPSK data. A spectrum extension is performed on the DFT pre-coded symbol where, last d/2 samples of the pre-coded data are copied and placed at the beginning of the symbol as pre-fix and then the initial d/2 samples of the pre-coded data are copied and placed at the end of the symbol as post-fix, where d is the spectrum extension factor. The results in an OFDM symbol of size M+d, which is represented as:

$${X}_{e x s} ( k ) = X ( ( k - \frac{d}{2} ) mod M )$$

Where, k=0, 1, . . . , M+d−1. In an embodiment, the excess bandwidth (or excess subcarriers) used may be arbitrarily high and may be more than M subcarriers.

The additional bandwidth that needs to be used for the spectrum extension is indicated to the user equipment (UE) by the base station (BS). The UE is also referred as user or mobile equipment. The BS is also referred gNB. The BS may indicate either extension on one side of the allocated bandwidth or two sides of the allocated bandwidth in steps of half PRB or one PRB. The signalling of the excess bandwidth may be done as a part of resource allocation. The Bandwidth extension on the either side of the allocated bandwidth may be almost equal such that the spectrum shaping filter can be symmetric. The spectrum extension may be asymmetric also, which means, the additional bandwidth on each side of the allocated bandwidth may be of different sizes.

Alternately, the BS may indicate a user with two parameters, i.e. usable BW where data is allocated, and excess BW where shaping is allowed. A BS scheduler may take care of these 2 parameters per UE as part of the entire scheduling operations.

When the excess BW is symmetric, it is assumed to have equal guard subcarriers on either side of the allocated spectrum. However, for asymmetric cases, an additional parameter which indicates the start location of the usable BW is indicated between UE and gNB. The spectrum extension factor depends on channel properties, allocation size, modulation order, coding rate, and RS, CP lengths. Pi/2-BPSK modulation is a special case, where spectrum extension may not be needed. The spectrum shaping is performed on the spectrum extended data by multiplying with the frequency response of the spectrum shaping filter. The spectrum shaped data is expressed using the equation,

$${X}_{s s} ( k ) = W ( k ) {X}_{e x s} ( k )$$

The filter W(k) is a frequency response of square root raise cosine, raised cosine, Hanning, Blackman or Hamming windows, or the filter is an oversampled Linearized Gaussian Minimal Shifting Keying (LGMSK) pulse. Otherwise, filter W(k) is the square root of the frequency response of the above-mentioned filters. The spectrum shaping filter either be specified by the base station or can be unknown at the base station. The spectrum shaping filter may be RAN1 specified or specification transparent. The spectrum shaping filter may or may not have zeros at the end, if it has zeros, it may be at the beginning, or at the end, or at the edges.

When spectrum extension factor ‘d’ is zero, no spectrum extension is performed, for example modulation schemes like pi/2-BPSK. In this case, spectrum shaping can be performed either in time-domain by circular convolving the data-RS multiplexed symbol with impulse response of the spectrum shaping filter or in frequency domain, where the DFT-pre-coded symbol is simply multiplied with the frequency response of the spectrum shaping filter. The spectrum shaping help in reduction of PAPR, which eventually results in better power efficiency. The spectrum shaped symbol data is operated with modules like subcarrier mapping, IFFT, WOLA, DAC before transmitting the symbol.

FIG. 3 shows a block diagram illustration of a communication system for generating an OTFDM waveform, in accordance with an alternate embodiment of the present disclosure.

As shown in the FIG. 3, the communication system 300 comprises a circular pulse shaping filter with excess bandwidth 310, WOLA unit 312 and a DAC 314. The communication system 300 also includes a processing unit to process the generated waveform. The communication system 300 is also referred to as a transmitter or an OTFDM transmitter or an OTFDM symbol generator. In an embodiment, the communication system 300 also includes a plurality of antennas for transmission of the generated waveforms.

The circular pulse shaping filtering 310 also referred to as pulse shaping filter or circular pulse shaping filtering with excess bandwidth or a shaping filter. The circular pulse shaping filter with excess bandwidth 310 is circular pulse shaping filter is obtained through circular convolution. A linear pulse shaping is obtained through a linear convolution. The OTFDM symbol may be oversampled to a higher rate and convolved with a linear or circular pulse shaping filter. When linear or circular pulse shaping is used, the signal is confined to OTFDM symbol interval. Alternatively, when linear pulse shaping is used, the signal is convolved continuously with a succession of OTFDM symbols, however, the transmitted signal is limited to the duration of the OTFDM symbols.

In an embodiment, the multiplexed symbol after oversampling can be represented by x′(n), where n=0, 1, . . . , qM−1. Where q is the oversampling factor. The oversampling sequence comprises of q−1 zeros inserted after each input sample of the time multiplexed RS and Data sequence. The multiplexed symbol x′(n) may be filtered with circular pulse shaping filter of M.

$${x}_{p s} ( n ) = {x}^{′} ( n ) ⊙ w ( n )$$

The shaping filter is a poly-phase filter using circular convolution operations. The filter w(n) is one of a square root raise cosine, a raised cosine, square root raised cosine, a Hanning, a Blackman, a Hamming window, an oversampled Linearized Gaussian Minimal Shifting Keying (LGMSK) pulse. In an embodiment, the filter w(n) is a square root of the frequency response of the above-mentioned filters. The spectrum shaping filter is either specified by a base station (BS) or unknown at the BS. The spectrum shaping filter may be specified in the standard or specification transparent. The spectrum shaping filter may or may not have zeros at the end, if it has zeros, it may be at the beginning, or at the end, or at the edges. The filtered symbol

$${x}_{p s}^{′} ( n )$$

is fed to the WOLA unit 312 followed by the DAC 314 before transmission. The transmitter 300 excludes either CP addition or CP removal which is performed after IFFT in traditional transmit methods.

In an embodiment, the transmitter 300 performs multiplexing of the data and the RS in one OTFDM symbol, with excess bandwidth and spectrum shaping. The spectrum shaped data is mapped on to the subcarriers allocated to the user, followed by an IFFT of size N to generate an OFDM waveform. The RS is one of a pi/2-BPSK, a QPSK, a ZC sequences, and an M-PSK sequences. The QPSK, pi/2-BPSK sequences are generated using the binary sequences from Walsh codes, or, m-sequences, Kasami sequences, gold sequences, or may be obtained from the pre-defined sequences, in an embodiment. The generation of said sequences for RS may depend on the cell/sector/Base station ID, scrambling ID, symbol number, sub frame number corresponding to the frame and the numerology. The ZC sequences generation is defined as

$$r ( n ) = {e}^{\frac{j u n ( n + 1 + 2 q )}{{N}_{ZC}}} ; n = \{ 0 , 1 , 2 , … … {N}_{ZC} - 1 \}$$

N_{ZC} is the length of the sequence that needs to be generated.

The RS sequence obtained using ZC is a plain ZC sequence or cyclically extended ZC sequence. The frequency spectrum of RS could be flat to ensure unbiased channel estimation. RS and CP for RS can occupy a portion of resources allocated to the user, which may depend on properties of channel conditions, excess bandwidth, user allocation size, modulation order, coding rate, and other parameters like impulse response of spectrum shaping filter.

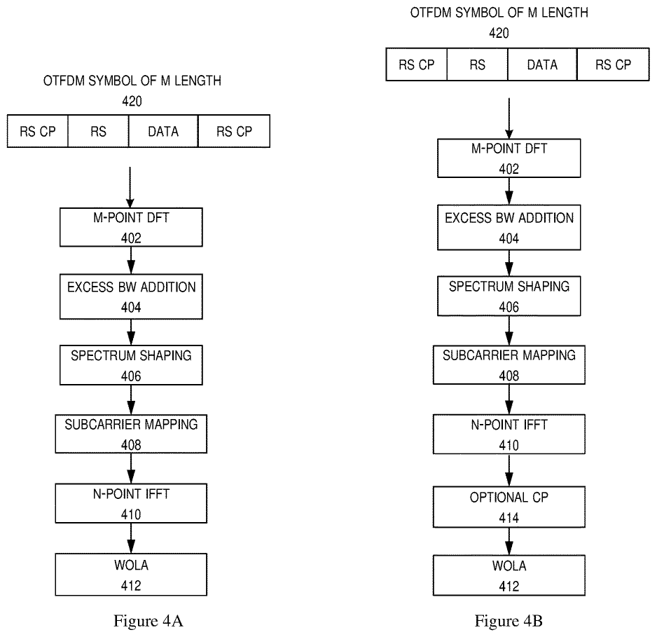

FIG. 4A shows an illustration of transmitting an OTFDM symbol 420 using a communication system, in accordance with an embodiment of the present disclosure.

As shown in the FIG. 4A, an OTFDM waveform is generated using an input OTFDM symbol 420 and transmitted using the associated antenna. The OTFDM symbol 420 is of length M, which is transformed using DFT 402 to obtain transformed sequences, followed by excess bandwidth (BW) addition 404 to obtain BW extended transformed sequence. In an embodiment, the DFT of 402 is a M-point DFT. The excess BW addition 404 on the transformed sequence comprises padding operation on the transformed sequence i.e. prefixing the transformed sequence with a first predefined number (N1) of subcarriers and post-fixing the transformed sequence with a second predefined number (N2) of subcarriers to obtain an extended bandwidth transformed sequence. The value of the N1 is at least zero, and value of the N2 is at least zero. The values of N1 and N2 may be same or different. The value of N1 and N2 may depend on the excess power that is sent by the transmitter.

The excess BW transformed sequence is shaped using the shaping unit or a filter 406, followed by subcarrier mapping 408 to obtained mapped sequence. The mapped sequence is transformed to time domain sequence using an IFFT unit 410. In an embodiment, the IFFT unit performs N-point IFFT. The time domain sequence is applied with a weighted with overlap and add operation (WOLA) 412 to perform windowing, weighted with overlap and add operation on the time domain sequence to reduce time domain signal discontinuities to generate an WOLA output, which is converted into an analog output waveform, referred as an OTFDM waveform by a DAC. The WOLA 412 or filtering after IFFT shapes the spectrum, reduces side lobes and improves PA efficiency.

In an embodiment, the output of IFFT unit 410 which is a time domain sequence is added with an optional post IFFT CP 414, followed by WOLA 412 and DAC conversion to generate corresponding OTFDM waveform for transmission. This is as shown in the FIG. 4B. The transmitter excludes either post IFFT CP addition or CP removal which is performed after IFFT in traditional transmit methods.

In an embodiment, the RS length in the OTFDM symbol is selected as a function of MCS or modulation type. Also, the data may include Phase tracking reference symbols (PT-RS). The PT-RS are RS without CP and may comprise of Short RS or discrete RS scattered in time. Additionally, the RS symbols with RS CP may be included.

As shown in FIGS. 4A-4B, the OTFDM symbol transmission is an example illustration. The communication system or transmitter is also used to generate and transmit a plurality of OTFDM symbols.

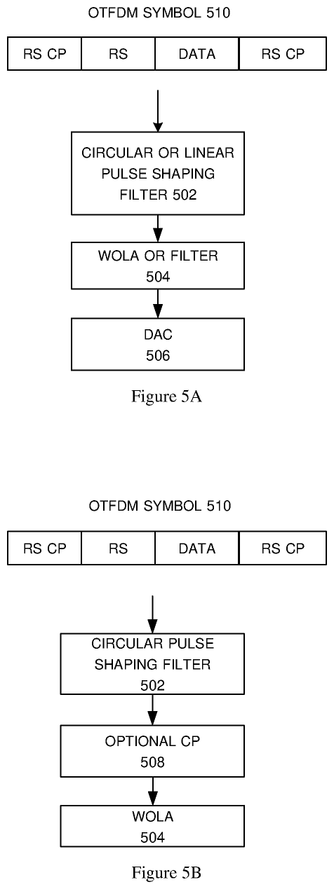

FIG. 5A shows an illustration of transmitting an OTFDM symbol using a communication system, in accordance with another embodiment of the present disclosure.

As shown in the FIG. 5A, an input OTFDM symbol 510 is processed to generate an OTFDM waveform and transmitted using the associated antenna. The OTFDM symbol is of length M, which is filtered using a circular pulse shaping filter or linear pulse shaping filter 502 to generate filtered symbols. The shaping filter is a poly-phase filter using circular convolution operations. The pulse shaping filter is either specified by a base station (BS) or unknown at the BS. The pulse shaping filter is either specified in the standard or specification transparent. The filtered symbol is fed to the WOLA unit 504 followed by DAC 506 before transmission using the antenna. In an embodiment, the filtered symbol is added with an optional CP 508, followed by WOLA 504 and DAC conversion which is as shown in FIG. 5B.

In an embodiment, the generated filtered OTFDM symbol transmission is a single shot transmission comprising at least one RS sequence, and at least one of data and control sequence and the said RS sequence is used to demodulate the said data or control sequence. In an embodiment, the filtered OTFDM symbol is an OFDM symbol.

In an embodiment, transmitting a slot comprises a plurality of OFDM symbols, said plurality of OFDM symbols includes at least one of: at least one symbol comprising of RS and data at least one symbol comprising of full RS, and at least one symbol comprising of full data. The plurality of OFDM symbols includes at least one of a symbol comprising of RS and data is filtered using a first filter, a symbol comprising of RS is filtered using a second filter, a symbol is filtered using a third filter, said filter have one on one correspondence among each other. The said filters are same, i.e. the first filter, the second filter and the third filter have same coefficients.

In an embodiment, the at least one RS is placed at one of starting position of the multiplexed sequence, ending position of the multiplexed sequence, at both the starting position and ending position of the multiplexed sequence, and at centre position of the multiplexed sequence.

In an embodiment, the transmission of the waveform being generated is being facilitated using a slot. The slot comprises a plurality of OFDM symbols, said plurality of OFDM symbols includes at least one of: at least one filtered-extended bandwidth DFT-s-OFDM symbol comprising of RS and data, at least one filtered-extended bandwidth DFT-s-OFDM symbol comprising of full RS, and at least one filtered-extended bandwidth DFT-s-OFDM symbol comprising of full data. The plurality of OFDM symbols includes at least one of a filtered-extended bandwidth DFT-s-OFDM symbol comprising of RS and data is filtered using a first filter, filtered-extended bandwidth DFT-s-OFDM symbol comprising of RS is filtered using a second filter, filtered-extended bandwidth DFT-s-OFDM symbol is filtered using a third filter, said filter have one on one correspondence among each other. The coefficients of the filters are the same.

The plurality of OFDM symbols includes at least one of a filtered-extended bandwidth DFT-s-OFDM symbol comprising of RS and data is filtered using a first filter, filtered-extended bandwidth DFT-s-OFDM symbol comprising of RS is filtered using a second filter, filtered-extended bandwidth DFT-s-OFDM symbol is filtered using a third filter, said filter have one on one correspondence.

One embodiment of the present disclosure is a method of processing a received waveform. The method comprising performing receiver filtering, by a receiver, on the received waveform to obtain a plurality of samples. Also, the method comprises collecting at least one of: at least one received RS and at least one data from the obtained samples of the received waveform, and performing channel estimation using the collected at least one received RS to obtain at least one estimated RS channel. Further, the method comprises equalizing the at least one received data using the at least one estimated RS channel to obtain at least one equalized data. Furthermore, the method comprises de-modulating the at least one equalized data using one of pi/2 Binary Phase Shift Keying (BPSK), Quadrature Phase Shift Keying (QPSK), and Quadrature Amplitude Modulation (QAM). Also, the method comprises collection of at least one data, at least one reference sequence (RS) and a portion of RS from the at least one equalized data. The method comprises phase estimation using the at least one RS or portion of at least one RS. In another embodiment, the method comprises phase compensation of the received data using the RS or the portion of RS using the estimated phase. Further, the method comprises phase compensation of the data performed using one or more RS included in the equalized data.

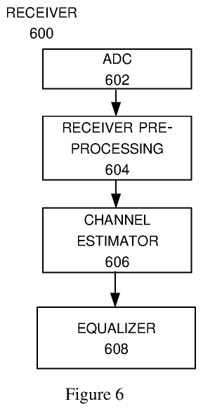

FIG. 6 shows a block diagram of a receiver, in accordance with an embodiment of the present disclosure. As shown in the FIG. 6, the receiver 600 comprises an analog to digital converter (ADC) 602, a receiver pre-processing unit 604, a channel estimator 606 and an equalizer 608.

The received signal is first processed using the front-end processing units such as, but not limited to ADC 602, time domain receiver filtering, CP removal that is based on the type of OTFDM symbol format used, FFT and subcarrier de-mapping.

In an embodiment where post IFFT CP is included at the transmitter, the FFT is applied on the entire received sequence excluding the post IFFT CP.

The allocated sub-carriers are de-mapped in the sub-carrier de-mapper, where allocated sub-carriers including the excess subcarriers are de-mapped from entire FFT output. If spectrum shaping performed at the transmitter is with square root of the frequency response of the spectrum shaping filter and filter is known at the receiver, then de-mapped subcarriers are multiplied with the complex-conjugate of the transmit filter used at the transmitter before further processing. This helps in maximizing the receiver SNR. If the filter is not known at the receiver, then the de-mapped data may be processed without any receiver shaping. The filter is referred to as subcarrier filter, which is one of SQRC, RC, Hanning, Hamming, Blackman, LGMSK pulses, and square root of these pulses.

The spectrum shaping filter used by the transmitter and receiver are the same and is indicated or pre-determined/a priori agreed, between the UE and BS. One example of such a filter is square root raised cosine pulse which is applied in the frequency domain (in both transmit and receiver sides).

In an embodiment, M frequency domain samples are obtained from M+d samples by taking DFT of size M+d, to obtain M. This is equivalent to spectrum folding operation. Expressed as:

$$\tilde{Y} ( k ) = \frac{1}{\sqrt{M}} {\sum }_{k = 0}^{M + d - 1} Y ( k ) {e}^{\frac{j 2 π ( k - \frac{d}{2} ) n}{M M}}$$

An IDFT of size M is taken over the effective data \tilde{Y}(k) to obtain the received data in time-domain, The IDFT output is given by \tilde{y}(n)

$$\tilde{y} ( n ) = \frac{1}{\sqrt{M}} {\sum }_{k = 0}^{M - 1} \tilde{Y} ( k ) {e}^{- \frac{j 2 π k n}{M 0 M}}$$

The Data and RS are de-multiplexed to collect RS samples for channel estimation. The channel estimation 606 is performed by one of a Least Squares method, Least Squares followed by time-domain interpolation or using an MMSE based estimation, time domain DFT based channel estimation. The length of the estimated channel depends on the number of samples to be equalized. From \tilde{y}(n), data with transmitted RS samples are demultiplexed. A DFT is applied on the demultiplexed data to obtain frequency domain data which is equalized by the equalizer 608 using the estimated channel. An IDFT is applied on the equalized data to recover the user data and the smaller RS chunks. The equalized user data further processed to obtain log-likelihood ratios (LLRs) and channel decoding and error check. When PT-RS is included in the data, the demultiplexed smaller RS chunks are used for phase estimation and phase compensation on the equalized data. Even in the absence of PT-RS, RS CP or RS CS which repeats in time may be used for phase tracking and compensation.

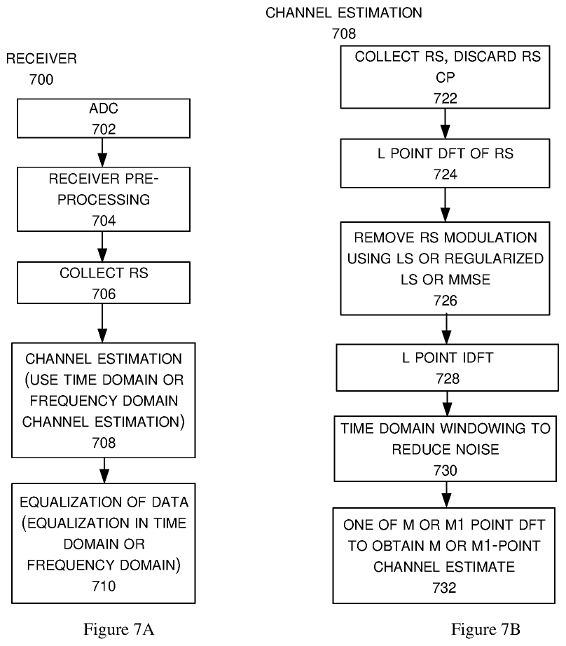

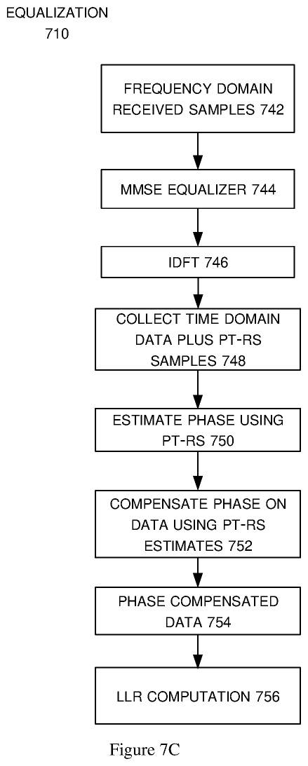

FIG. 7A shows a block diagram of a receiver, in accordance with some embodiments of the present disclosure.

As shown in the FIG. 7A, the receiver 700 comprises an analog to digital converter (ADC) 702, receiver pre-processing unit 704, RS collection unit 706, a channel estimator 708 and an equalizer 710. The received signal is first processed using the front-end processing units such as, but not limited to ADC 702, low pass filtering, sample rate converter. The output of the receiver pre-processing 704 is of length M, which will be used for channel estimation 708 and equalization 710. From the output of pre-processing, the RS samples are collected using the collecting unit 706. The RS samples excludes prefix and suffix is used for channel estimation. The equalization is performed on the data using the estimated channel to obtain an equalized sequence.

FIG. 7B shows an illustration of a channel estimation 708 performed by the receiver of FIG. 7A, in accordance with some embodiments of the present disclosure. As shown in the FIG. 7B, the channel estimation unit 708 receives output of collect RS unit, The channel estimation unit discards the RS CP (in case of OTFDM symbol is as per FIG. 1B) collects RS 722 and performs L-point DFT on the RS 724 to obtain transformed RS. The channel estimation unit performs filtering on the transformed RS to remove RS modulation scheme from the using one of LS or regularised LS or MMSE 726. The filtered transformed RS is converted into time domain using L-point IDFT 728, followed by time domain windowing to reduce noise 730 and obtain time domain sequence. Thereafter, DFT of required size (as an example one of M or M1 points) is applied on the time domain sequence to the channel estimate 732.

FIG. 7C shows an illustration of an equalization 710 performed by the receiver of FIG. 7A, in accordance with some embodiments of the present disclosure. As shown in FIG. 7C, the received frequency domain data plus a portion of RS samples 742 are equalized using MSME equalizer 744. In an embodiment, the equalizer is one of MMSE, ZF, MF, and IRC based equalizer. The equalized sequence is transformed to time domain using IDFT 746, followed by collecting the time domain data and PR-RS 748. A phase estimation is performed on the PT-RS or exploiting both PT-RS and the RS CP samples which repeat in with in the OTFDM symbol 750, which is used to compensate the phase of data 754. The compensated data is decoded using Log likelihood ratio (LLR) computations 756 to detect the received signal.

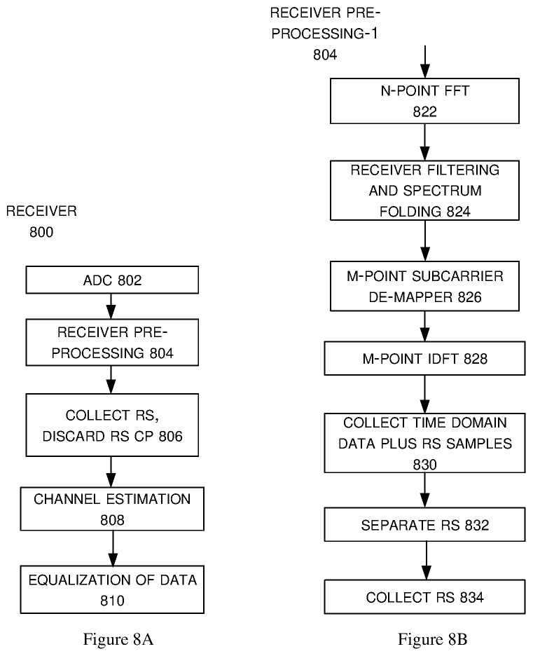

FIG. 8A shows a block diagram of a receiver, in accordance with another embodiment of the present disclosure. As shown in the FIG. 8A, the receiver 800 comprises an analog to digital converter (ADC) 802, receiver pre-processing unit 804, RS collection unit 806, a channel estimator 808 and an equalizer 810. A received signal is first processed using the front-end processing units such as, but not limited to ADC, low pass filtering, sample rate sampler and subcarrier de-mapping. The output of the receiver pre-processing 804 is of length M, which will be used for channel estimation 808 and an equalization 810. From the output of pre-processing, the RS samples are collected using the collecting unit. The RS is without prefix and suffix is used for channel estimation using one of Least Squares method, or Least Squares, followed by time-domain interpolation or using an MMSE based estimation, or using time domain DFT based channel estimation. The length of the estimated channel depends on the number of samples to be equalized. The equalization is performed on the RS using the estimated channel to obtain an equalized sequence.

FIG. 8B shows an illustration of a portion of the receiver pre-processing unit of the receiver of FIG. 8A, in accordance with an embodiment of the present disclosure. As shown in the FIG. 8B, the receiver pre-processing unit 804 receives the digital sequences from the ADC 802. The pre-processing unit performs N-point FFT 822 the received signal. The CP may be excluded to obtain N-samples in case CP was included at the transmitter. After subcarrier de-mapping including excess subcarriers 826, receiver filtering and spectrum folding 824 is performed to obtain M-point filtered and folded sequence. The filtered and folded sequence is converted into time domain using N-point IDFT 828, to obtain time domain sequence. Next, the Data and RS are separated 832 from the time domain sequence. The time domain RS and Data samples are collected 834 and used for channel estimation and equalization.

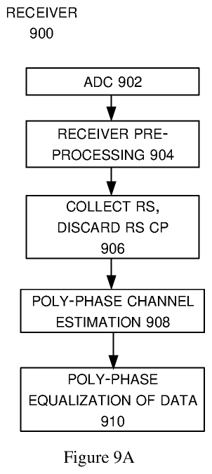

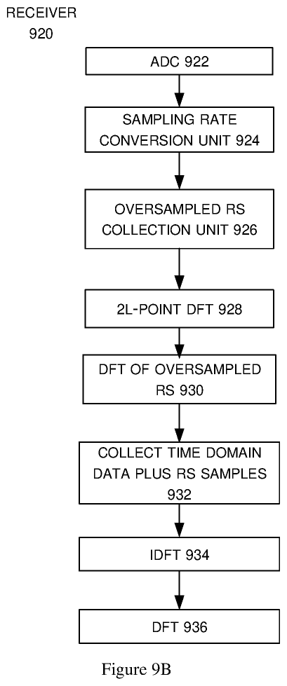

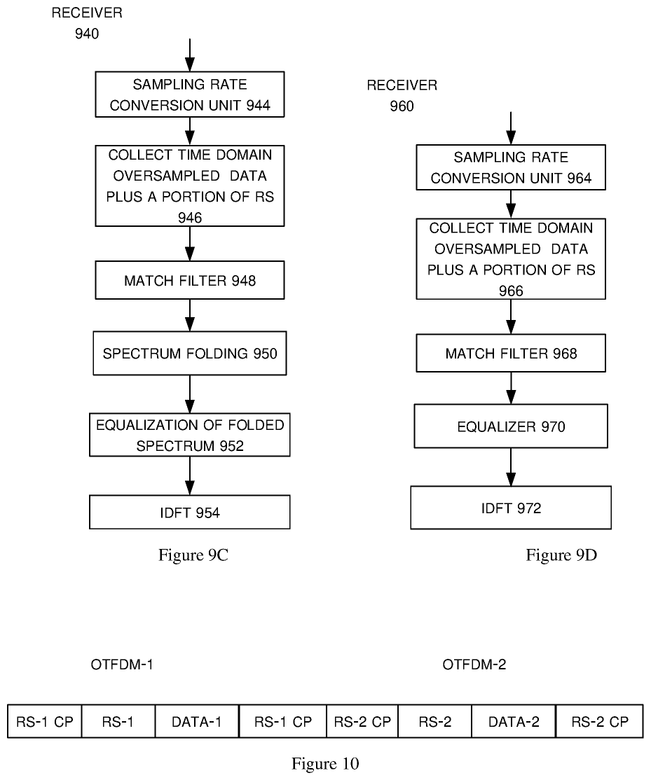

FIG. 9A shows a block diagram of a receiver, in accordance with yet another embodiment of the present disclosure. As shown in the FIG. 9A, the receiver 900 comprises an analog to digital converter (ADC) 902, receiver pre-processing unit 904, RS collection unit 906, a poly phase channel estimation unit or poly phase channel estimator 908 and a poly phase equalizer or a poly phase equalization of data 910. A received signal is first processed using the front-end processing units such as, but not limited to ADC, low pass filtering, sample rate converter. The output of the receiver pre-processing is of length at least 2M, which will be used for channel estimation and equalization. From the output of pre-processing, at least 2L RS samples are collected using the collecting unit. The RS is without prefix and suffix is used for channel estimation. The channel estimation is poly-phase channel estimation.

In an embodiment, the 2L RS samples are divided into even and odd streams by alternatively collecting the samples. The channel estimation 908 is performed on the even and odd sequences to obtain even and odd channel estimates. The equalizer is a poly-phase equalizer 910 which performs equalization on the data using the estimated poly-phase channel to obtain an equalized sequence. The time domain signal comprising of data is divided into even and odd sequences. The equalization is performed on the even and odd sequences using the even and odd estimated channels. The equalization includes application of matched filter on even and odd sequences separately and combined the matched filtered outputs and equalize the combined signal.

FIG. 9B shows a block diagram of a receiver, in accordance with yet another embodiment of the present disclosure. As shown in the FIG. 9B, the receiver 920 comprises a sampling rate conversion unit 924 to obtain 1*M samples per OTFDM symbol from ADC 922 output. In an embodiment 1 takes a value of 2. The RS of length at least 2*L without prefix or suffix is collected for channel estimation. When l=−2, at least 2L point DFT is applied on the 2L length RS. In frequency domain the RS includes more than L subcarriers because of excess subcarriers spectrum shaping. Since, in time domain RS can be represented as a circular convolution of a length 2L oversampled RS sequence 926 and 2L length channel, in frequency domain, the DFT 928 of RS repeats at twice and multiplied with the DFT of the channel. The DFT 930 of RS is known and therefore removed from the DFT if the RS using LS or MMSE or regularized LS methods through weighing of DFT of RS. After RS removal 2L point IDFT 934 is taken to obtain 2L point channel estimate. A time domain window is applied on the estimated channel and a DFT 936 of suitable length (for example either 2M, or 2M0 or 2M1) is taken on the windowed channel estimate to obtain estimated channel that is used for equalization.

FIG. 9C shows a block diagram of a receiver, in accordance with yet another embodiment of the present disclosure. As shown in the FIG. 9C, the receiver 940 comprises sampling rate conversion of the input to obtain l*M samples per OTFDM symbol 944, followed by collection of either lM, or lM0 or lM1 samples as per the configuration 946 and applies a DFT. The matched filter 948 is applied using the estimated channel as described in FIG. 9B. The spectrum is folded by 950 to combine the excess subcarriers. For instance, M+d subcarriers are the occupied subcarriers, and after spectrum folding there are M subcarriers. An equalization is performed after the spectrum folded sequence 952. An IDFT 954 is applied on the equalized sequence which gives the equalized time domain data multiplexed with a portion of RS.

FIG. 9D shows a block diagram of a receiver, in accordance with yet another embodiment of the present disclosure. As shown in the FIG. 9D, the receiver 960 comprises of collection of either M0 or M1 samples as per the configuration 966 and applies a DFT. The matched filter 968 is applied using the estimated channel followed by the equalization 970. Thereafter, an M0 or M1 point IDFT 972 gives the equalized time domain data multiplexed with a portion of RS.

FIG. 10 shows an illustration of OTFDM symbol structures, in accordance with some example embodiments of the present disclosure. As shown in the FIG. 10, each of the OTFDM symbol comprises RS-CP, RS, data and RS-CP i.e. there are two OTFDM symbols. The first OTFDM symbol (OTFDM-1) includes RS-1 CP, RS-1, data-1 and RS-1 CP, and the second OTFDM symbol (OTFDM-2) includes RS-2 CP, RS-2, data-2 and RS-2 CP. The RS-1 and RS-2 are reference signal sequences that are selected or generated as a function of OTFDM/OFDM symbol number, the Cell ID or sector ID, and an antenna port. In an embodiment, the RS may repeat every frame or multiple frames. This can be ensure making RS generation a function of OTFDM symbol number and the number of symbols in a frame for example, the RS generation is a function of modulo (OTFDM symbol number, Number of OTFDM symbols in a frame). In an embodiment OTFDM symbol may be referred to as OFDM symbol.

Also in an embodiment, the RS length may be selected as a function of MCS or modulation type. The data may include Phase tracking reference symbols (PT-RS). The PT-RS are RS without CP and may comprise of Short RS or discrete RS scattered in time. An additional RS symbols with RS CP may be included in the symbol structure, in an embodiment.

One embodiment of the present disclosure is related to multi-antenna or multi-user transmission or multiple input multiple output (MIMO) transmitter.

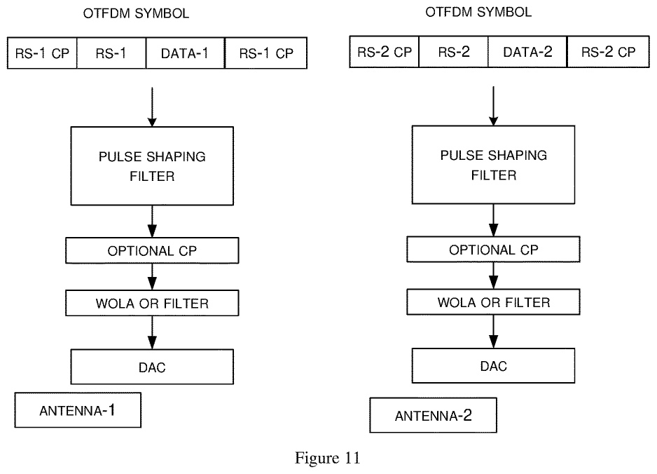

FIG. 11 shows an illustration of transmitting a plurality of OTFDM symbols using a communication system, in accordance with an embodiment of the present disclosure. The communication system is a multi-antenna or multi-user transmission system or multiple input multiple output (MIMO) system or MIMO transmitter.

As shown in the FIG. 11, the communication system comprises a pulse shaping filter also referred as a circular pulse shaping filter unit, WOLA unit, a DAC unit and a plurality of antennas. The communication system also includes an optional CP unit and a processing unit to process the generated waveform, in an embodiment. The circular pulse shaping filtering unit or shaping filter unit performs filtering of the input OTFDM symbols. The shaping filter is a poly-phase filter using circular convolution operations which is similar to the shaping filter as shown in FIG. 4*. The filter w(n) is one of a square root raise cosine, a raised cosine, a Hanning, a Blackman, a Hamming window, an oversampled Linearized Gaussian Minimal Shifting Keying (LGMSK) pulse. In an embodiment, the filter w(n) is a square root of the frequency response of the above-mentioned filters. The spectrum shaping filter is either specified by a base station (BS) or unknown at the BS. The spectrum shaping filter is RAN1 specified or specification transparent. The spectrum shaping filter may or may not have zeros at the end, if it has zeros, it may be at the beginning, or at the end, or at the edges.

The circular pulse shaping filter unit includes an excess bandwidth filter which is referred to as circular pulse shaping filter with excess bandwidth. The circular pulse shaping filter is obtained through a circular convolution. In an embodiment the shaping filter is a linear pulse shaping filter, which is obtained through a linear convolution.

In an embodiment, the method as shown in FIG. 11 may be extended to more than 2 antennas. This is for SU MIMO in DL or UL or MU-MIMO in DL or UL. The data fed to the layers is encoded jointly or separately. Also, the existing 5G NR methods are applicable. In an embodiment, the shaping filter unit includes a plurality of shaping filters to perform filtering of the associated input OTFDM symbols and generated associated filtered OTFDM symbols.

The filtered symbols

$${x}_{p s}^{′} ( n )$$

associated with both the input OTFDM symbols, as shown in FIG. 11, are fed to the corresponding WOLA unit followed by the associated DAC before transmission using the corresponding antennas (Antenna-1 and antenna-2). In an embodiment, the filtered symbols are added with an optional post IFFT CP, followed by WOLA and DAC conversion. The transmitter excludes either CP addition or CP removal which is performed after IFFT in traditional transmit methods.

As shown in FIG. 11, the 2 OTFDM symbol transmission using at least two antenna ports is an example illustration. Similarly, the same communication system or transmitter is used to generate and transmit a plurality of OTFDM symbols using a plurality of antenna ports. In an embodiment the first OTFDM symbols associated with a first antenna port is transmitted through one more first group of physical power amplifiers that are associated with one of more first group of physical antennas. The signal to the PA may be multiplied using a weight which may be applied in the baseband or RF section. The weight is preferably a phase weight so that the PAPR experienced by the signal input to the first group of PAs is similar to the PAPR of the first OTFDM symbol. The second OTFDM symbols associated with a second antenna port is transmitted through one more second group of physical power amplifiers that are associated with one of more second group of physical antennas. The signal to the PA may be multiplied using a weight which may be applied in the baseband or RF section. The weight is preferably a phase weight so that the PAPR experienced by the signal input to the second group of PAs is similar to the PAPR of the second OTFDM symbol. When the first and second group of antenna and physical PAs are distinct, the PAs experience low PAPR signal inputs. When first and second group of physical PAs are the same, the PAPR experienced by the PA will be high. In an embodiment the control PSS, SSS, PBCH, PDCCH and PDSCH signals may be transmitted using the first OTFDM symbol using a single antenna port using multiple PAs and multiple antennas.

In an embodiment, the RS-1 and RS-2 are distinct sequences that enables estimation of propagation channel associated with first and second antenna ports. In an embodiment where PT-RS is embedded in the data the PT-RS associated with first and second OTFDM symbols may be same or different. The channel estimated using the RS-1 and RS-2 may be used to equalize the data that includes PT-RS.

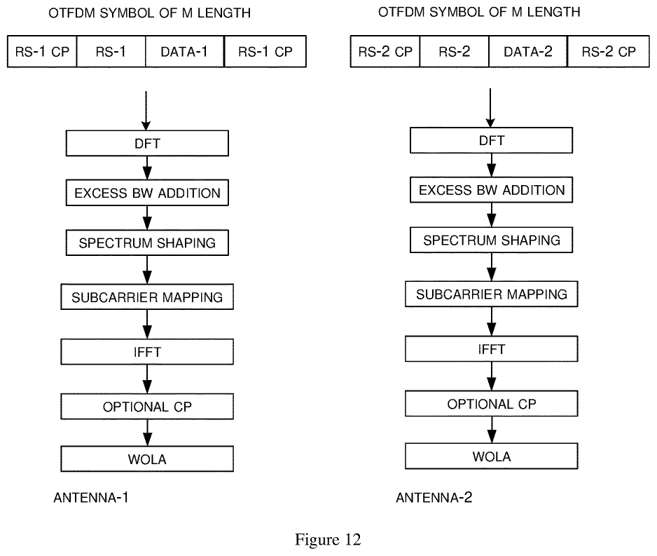

FIG. 12 shows an illustration of transmitting a plurality of OTFDM symbols using a communication system, in accordance with another embodiment of the present disclosure. The communication system is a multi-antenna or multi-user transmission system or multiple input multiple output (MIMO) system or MIMO transmitter.

As shown in the FIG. 12, two OTFDM waveforms are generated using the two input OTFDM symbols and transmitted using the associated antennas. The OTFDM symbols are of length M, are transformed using DFT to obtain transformed sequences, followed by excess bandwidth (BW) addition to obtain BW extended transformed sequence. The excess BW addition on the transformed sequence comprises padding operation on the transformed sequence i.e. prefixing the transformed sequence with a first predefined number (N1) of subcarriers and post-fixing the transformed sequence with a second predefined number (N2) of subcarriers to obtain an extended bandwidth transformed sequence. The value of the N1 is at least zero, and value of the N2 is at least zero. The values of N1 and N2 may be same or different. The value of N1 and N2 may depend on the excess power that is sent by the transmitter.

The excess BW transformed sequences are shaped using the shaping unit or a filter, followed by subcarrier mapping to obtained mapped sequences. The mapped sequences are transformed to time domain sequences using corresponding IFFTs. The time domain sequences are added with an optional CP, followed by WOLA and DAC conversion to generate corresponding OTFDM waveform for transmission. The transmitter excludes either CP addition or CP removal which is performed after IFFT in traditional transmit methods.

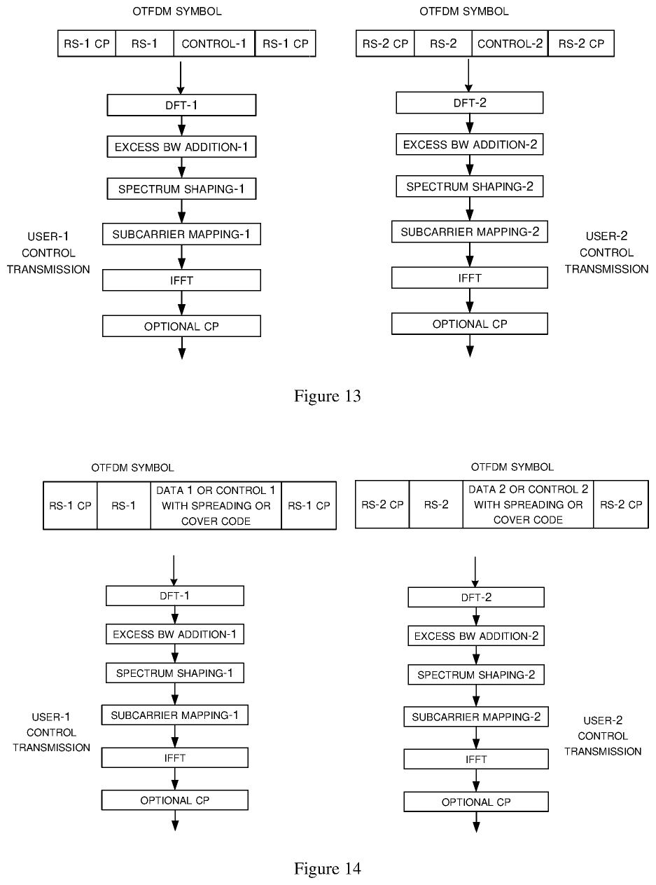

FIG. 13 shows an illustration of transmitting a plurality of OTFDM symbols using a communication system, in accordance with another embodiment of the present disclosure. The communication system is a multi-antenna or multi-user transmission system or multiple input multiple output (MIMO) system or MIMO transmitter. The communication system performs multi-user transmission, where user-1 and user-2 are mapped to non-overlapping subcarrier locations i.e. frequency multiplexing is performed. The OTFDM symbol comprises control information or control data sequences. In an embodiment, at least one of a data spreading or a cover code is applied on the control sequences.

As shown in the FIG. 13, two OTFDM waveforms are generated using the two input OTFDM symbols and transmitted using the associated antennas. The first OTFDM symbol structure includes RS-1 CP, RS-1, Control-1 and RS-1 CP. The second OTFDM symbol structure includes RS-2 CP, RS-2, Control-2 and RS-2 CP. The two OTFDM symbols are transformed using corresponding DFTs (DFT-1 and FT-2) to obtain corresponding transformed sequences, which are extended using associated excess bandwidth (BW) addition unit (excess BW addition-1 and excess BW addition-2) to obtain corresponding BW extended transformed sequences. The excess BW addition performed on each of the transformed sequence comprises padding operation on the transformed sequence i.e. prefixing the transformed sequence with a first predefined number (N1) of subcarriers and post-fixing the transformed sequence with a second predefined number (N2) of subcarriers to obtain an extended bandwidth transformed sequence. The value of the N1 is at least zero, and value of the N2 is at least zero. The values of N1 and N2 may be same or different. The value of N1 and N2 may depend on the excess power that is sent by the transmitter.

The excess BW transformed sequences are shaped using corresponding shaping unit or a filter, followed by corresponding subcarrier mapping to obtained mapped sequences. The mapped sequences are transformed to time domain sequences using corresponding IFFTs. The time domain sequences are added with an optional CP, followed by WOLA and DAC conversion to generate corresponding OTFDM waveforms for transmission. The transmitter excludes either CP addition or CP removal which is performed after IFFT in traditional transmit methods. The generated OTFDM waveforms are user-1 control OTFDM and user-2 control OTFDM waveforms.

FIG. 14 shows an illustration of transmitting a plurality of OTFDM symbols using a communication system, in accordance with yet another embodiment of the present disclosure. The communication system is a multi-antenna or multi-user transmission system or multiple input multiple output (MIMO) system or MIMO transmitter. The communication system performs multi-user transmission, where user-1 and user-2 are mapped to non-overlapping subcarrier locations i.e. frequency multiplexing is performed. The OTFDM symbol comprises control information or control data sequences on which at least one of a spreading or a cover code is applied.

As shown in the FIG. 14, two OTFDM waveforms are generated using the two input OTFDM symbols and transmitted using the associated antennas. The first OTFDM symbol structure includes RS-1 CP, RS-1, Data-Control-1 and RS-1 CP. The second OTFDM symbol structure includes RS-2 CP, RS-2, Data-Control-2 and RS-2 CP. At least one of data spreading and code cover operations is performed on the Data-Control-1 and Data-Control-2 sequences associated with the OTFDM symbols.

The two OTFDM symbols are transformed using corresponding DFTs (DFT-1 and FT-2) to obtain corresponding transformed sequences, which are extended using associated excess bandwidth (BW) addition unit (excess BW addition-1 and excess BW addition-2) to obtain corresponding BW extended transformed sequences. The excess BW addition performed on each of the transformed sequence comprises padding operation on the transformed sequence i.e. prefixing the transformed sequence with a first predefined number (N1) of subcarriers and post-fixing the transformed sequence with a second predefined number (N2) of subcarriers to obtain an extended bandwidth transformed sequence. The value of the N1 is at least zero, and value of the N2 is at least zero. The values of N1 and N2 may be same or different. The value of N1 and N2 may depend on the excess power that is sent by the transmitter.

The excess BW transformed sequences are shaped using corresponding shaping unit or a filter, followed by corresponding subcarrier mapping to obtained mapped sequences. The mapped sequences are transformed to time domain sequences using corresponding IFFTs. The time domain sequences are added with an optional CP and DAC conversion to generate corresponding OTFDM waveforms for transmission. The generated OTFDM waveforms are user-1 control OTFDM and user-2 control OTFDM waveforms.

Further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

A description of an embodiment with several components in communication with each other does not imply that all such components are required. On the contrary a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method for generating a symbol, the method comprising:
generating, by a transmitter, at least one data sequence, at least one reference sequence (RS) and a portion of at least one RS, said at least one RS comprises at least one of a RS block, a RS cyclic prefix (CP) and a RS cyclic suffix (CS);
time multiplexing, by the transmitter, the at least one data sequence with the at least one RS to generate a multiplexed sequence; and
filtering, by the transmitter, the multiplexed sequence to obtain a symbol.

2. The method as claimed in claim 1, wherein the method comprises generating a waveform using the obtained symbol, said generating a waveform comprising at least one of up-sampling, time domain filtering, weighted overlap and add (WOLA) and digital to analog conversion (DAC), frequency up-conversion.

3. The method as claimed in claim 1, wherein a portion of the at least one RS is appended at the tail end of the symbol.

4. The method as claimed in claim 1, wherein a portion of at least one RS is the RS CP.

5. The method as claimed in claim 1, wherein a portion of at least one RS is portion of RS CP.

6. The method as claimed in claim 1, wherein a portion of at least one RS is the RS CP and the RS CS.

7. The method as claimed in claim 1, wherein a portion of at least one RS is a portion of the RS CP and the RS CS.

8. The method as claimed in claim 1, wherein the at least one data sequence is one of a pi/2 binary phase shift keying (BPSK) sequence, a BPSK sequence, a Quadrature Phase Shift Keying (QPSK) sequence, M-ary Quadrature Amplitude Modulation (QAM) sequence, and an M-ary Phase Shift Keying (PSK) sequence.

9. The method as claimed in claim 1, wherein the at least one data sequence comprises at least one of a data block, data cyclic prefix and a data cyclic suffix.

10. The method as claimed in claim 1, wherein the at least one data sequence comprises at least one data block and a phase tracking reference signal (PTRS).

11. The method as claimed in claim 1, wherein the at least one data sequence includes at least one of a user data and a control information.

12. The method as claimed in claim 1, wherein when the at least one data sequence and the at least one RS sequence are pi/2-BPSK, wherein the multiplexed sequence is rotated by 90 degrees between successive elements of the multiplexed sequence to generate a rotated multiplexed sequence.

13. The method as claimed in claim 1, wherein the at least one data sequence includes at least one data, and at least one of a data cyclic prefix (CP) and a data cyclic suffix (CS).

14. The method as claimed in claim 1, wherein the at least one RS is one of a pi/2 binary phase shift keying (BPSK) sequence, a BPSK sequence, a Zadoff-Chu (ZC) sequence, a Quadrature Phase Shift Keying (QPSK) sequence, a M-ary Phase Shift Keying (PSK) sequence and a computer-generated sequence.

15. The method as claimed in claim 1, wherein the multiplexed sequence comprises two reference sequences (RSs), a first RS is located at RS starting position of multiplexed sequence and a second RS is located at RS ending position of multiplexed sequence.

16. The method as claimed in claim 1, wherein the tail of the data is appended with a portion of data CP and data CS, said portion repeats in two different places within the OTFDM symbol, wherein the data CP and the data CS which repeat in time is used for estimation of time varying phase within the OTFDM symbol

17. The method as claimed in claim 1, wherein the at least one RS sequence includes at least one RS block, at least one of a RS cyclic prefix (CP) and a RS cyclic suffix (CS).

18. The method as claimed in claim 1, wherein the at least one RS or a portion of the at least one RS is generated as a function of at least one of a Base Station ID, Sector ID, Transmitter ID and UE ID.

19. The method as claimed in claim 1, wherein a tail of data is appended with a portion of RS CP, said portion of RS CP repeats in three different places within the OTFDM symbol.

20. The method as claimed in claim 1, wherein the tail of data is appended with a portion of DS CP and Data CS, said portion repeats in two different places within the OTFDM symbol, wherein the data CP and the data CS which repeat in time is used for estimation of time varying phase within the OTFDM symbol.

21-45. (canceled)
